(19) United States
(12) Patent Application Publication
(10) Pub. No.: US 2008/0100982 A1
(43) Pub. Date: May 1, 2008

(54) System and method for dissipating static electricity in an electronic sheet material dispenser

(76) Inventors: Richard P. Lewis, Marietta, GA (US); Paul Tramontina, Alpharetta, GA (US); Leslie Dobbins, Mableton, GA (US); Charles A. Osborne, Cumming, GA (US)

Correspondence Address: DORITY & MANNING, P.A., POST OFFICE BOX 1449, GREENVILLE, SC, 29602-1449, US

(21) Appl. No.: 11/589,682

(22) Filed: Oct. 30, 2006

(51) Int. Cl. H01H 47/00

(52) U.S. Cl. 361/220

(57) ABSTRACT

An electronic dispenser for dispensing a measured sheet from a roll of web material includes an antenna in conductive communication with at least one component of the dispenser that stores static charge generated by operation of the dispenser. The antenna is disposed so as to dissipate the static charge through a non-conductive material external to the dispenser housing.

### FIELD OF THE INVENTION

The present invention relates generally to the field of electronic dispensers for dispensing lengths of sheet material, such as towel or tissue material, from a roll, and more particularly to a system and method for dissipating static electricity generated in such dispensers.

### BACKGROUND

Electronic sheet material dispensers are well know in the art, including dispensers that automatically dispense a metered length of towel or tissue material upon sensing the presence of a user. This type of dispenser has become known in the art as a “hands-free” dispenser in that it is not necessary for the user to manually actuate or otherwise handle the dispenser to initiate a dispense cycle.

The control systems and mechanical aspects of conventional hands-free dispensers are wide and varied.

A common problem associated with conventional electronic dispensers is the buildup and discharge of static electricity generated during the dispense cycle. A static charge may be generated in the dispenser from any number of components or operations, such as the movement of the paper web over various rollers or other guide structure, interaction between guide rollers, and so forth. The static charge can be relatively small, or up to about thirty or more kilovolts. If not grounded or dissipated, this charge may result in the user receiving an unpleasant “static shock” when using the dispenser. The charge may also be detrimental to the dispenser's electronic control circuitry, particularly the relatively sensitive sensor circuitry.

Efforts have been made in the past to ground the charge-generating components of the dispenser, such as the drive roller, to a ground surface within or external to the dispenser. Other methods include grounding components through a ground connection of the electronic circuitry. These methods, however, require a readily accessible ground, such as an existing ground connection of a conventional AC power supply system, a grounded plumbing component, a dedicated grounding rod, or the like. Unfortunately, it is often the case that battery-powered electronic sheet material dispensers are not located in close proximity to a readily accessible ground connection. For example, the wall of a public restroom or, the walls of a toilet enclosure in the case of a toilet tissue dispenser, may not provide an accessible ground connection. In this situation other measures are necessary.

U.S. Pat. Nos. 6,871,815 and 7,017,856 propose a system wherein a high-conductivity pathway (i.e., a wire) is used to connect internal components of the dispenser that are subject to static charge buildup to a mechanical contact on the back of the dispenser housing. This contact, in turn, makes contact with the supporting wall upon which the dispenser is mounted, with the premise being that any static charge will be dissipated by the wall.

The art is thus constantly seeking ways to improve upon conventional electronic sheet material dispensers, and the present disclosure relates to an alternative unique system and method for dissipating static charge buildup in such dispensers.

### SUMMARY

Objects and advantages of the invention will be set forth in part in the following description, or may be obvious from the description, or may be learned through practice of the invention.

An electronic sheet material dispenser is provided for dispensing a measured sheet of web material, such as towel or toilet tissue material. It should be appreciated by those skilled in the art that the present invention is not limited to any particular type of electronic sheet material dispenser, and has utility for any dispenser wherein it is desired to dissipate static charge build-up. The dispenser may be a “hands-free” dispenser that is automatically actuated upon detection of an object placed within a defined detection zone. In alternative embodiments, the dispenser may be actuated upon the user pressing a button, switch, or other manual actuating device to initiate a dispense sequence. The dispenser may be battery powered, AC powered (with an appropriate transformer and adapter), or capable of being switched between battery power and AC power.

The dispenser includes a housing having an internal volume so as to retain at least one roll of web material therein. In a particular embodiment, the housing is configured to retain a primary reserve roll and a depleted stub roll, with an automatic transfer mechanism to automatically switch to the primary roll once the stub roll is depleted. The housing may take on any desirable and aesthetically pleasing configuration, and may include a back member and removable cover member. The cover member may be hinged relative to the back member to provide access to the interior volume and components of the dispenser.

The dispenser includes an electronically powered dispensing mechanism contained within the housing for dispensing a measured sheet from the roll of web, for example upon a valid detection of an object in the detection zone. Numerous configurations of electrically driven dispensing mechanisms are known in the art and may be configured for use with the present dispenser. In a particular embodiment, a separate chassis or module is received in the housing, the module having the dispensing mechanism mounted therein. The mechanism may include a drive roller and associated components, a pressure roll assembly, and a tear bar. The pressure roll assembly typically includes a pressure roll biased by springs against the drive roller, with the web material passing between the pressure roll and drive roller. An opening for the towel material is defined in the module and aligns with a dispensing opening in the housing.

In an embodiment wherein the dispenser dispenses from a stub roll and subsequently from a reserve or “main” roll, the chassis may include main roll holders and stub roll holders for rotatably supporting the respective rolls in a position within the module for unobstructed dispensing therefrom. An automatic transfer mechanism can be provided to transfer dispensed towel material from the stub roll to the main roll when the stub roll is nearly fully depleted.

A roll-size (“fuel”) gauge may be configured in the module to indicate to service or maintenance personnel when the main roll has been depleted a sufficient amount to be moved to the stub roll position. This gauge may be a member that is biased against the outer circumferential surface of the main roll such that it tracks with the decreasing diameter of the main roll as the web material is depleted. When the main roll reaches a certain depleted diameter, the gauge may activate a switch causing an LED to light, or other indicator, to indicate that the main roll is depleted and should be replaced. Alternatively, the indicator may be a mechanical type, such as a flag that becomes visible upon the diameter of the main roll being sufficiently reduced.

The dispensing mechanism dispenses a measured length or sheet of the web material, which may be accomplished by various means, such as a timing circuit that stops the drive roller after a predetermined time. In a particular embodiment, a revolution counter is provided that measures the degree of rotation of the drive roller and is interfaced with control circuitry to stop a drive roller motor after a defined number of revolutions of the roller. This counter may be an optical encoder type of device, or a mechanical device. The control circuitry may include a device to allow maintenance personnel to adjust the sheet length by increasing or decreasing the revolution counter set point.

The drive mechanism may include a drive motor and gear assembly mounted in the module, the gear assembly transmitting motive force from the motor to the drive roller. The web material passes through the nip defined by the drive roller and pressure roller such that rotation of the drive roller causes the material to be advanced out through the dispensing throat of the housing. A tear bar is disposed in the throat so that a user can separate a sheet of the material by grasping and pulling the sheet across the tear bar. In an alternative embodiment, an automatic cutting device may be provided to automatically cut the sheet of material.

In the case of an automatic dispenser, a sensor may be provided to detect an object placed in a detection zone external to the dispenser. This sensor may be a passive sensor that detects changes in ambient conditions, such as ambient light, capacitance changes caused by an object in a detection zone, and so forth. In an alternate embodiment, the sensor is an active device and includes an active transmitter and associated receiver, such as one or more IR transmitters and IR receiver. The transmitter transmits an active signal in a transmission cone corresponding to the detection zone, and the receiver detects a threshold amount of the active signal reflected from an object placed into the detection zone. Control circuitry is configured with the sensor for initiating a dispense cycle upon a valid detection signal from the receiver.

An antenna in provided in conductive communication with at least one internal component of the dispenser that stores static charge generated upon operation of the dispenser. The component may be any one or combination of elements that are susceptible to generating or storing static charge. For example, the component may be the shaft or surface of the drive roller or pressure roller. The component may be the tear bar against which the web material is pulled in order to separate a sheet of the material, or the fuel gauge bar that is biased against the main roll. In still alternate embodiments, the component may be the web material itself.

The antenna is in electrical conductive communication with the component by any conventional low impedance means. For example, the component may be connected to the antenna through a wire, foil, or other conductive path. Any manner of conventional electrical connection may be used to interconnect the antenna, conductive members, and component.

The antenna may be a single point or multiple point array, and may be made from any material suitable for electrostatic conduction and ionization of air. For example, the antenna may constitute an exposed wire, strip of sheet metal, foil, or the like. The dissipation system is not limited by the type or configuration of the antenna or materials. The antenna is desirably electrically isolated from other components of the dispenser and disposed so as to dissipate the static charge through a non-conductive material external to the dispenser housing. In a particular embodiment, the antenna is housed within a compartment that is open to external air so that the static charge is dissipated through the air by corona discharge. This compartment may be defined by a component of the housing, for example within an external wall of the dispenser housing. In a particular embodiment, the antenna is disposed within a compartment defined in the back wall of the dispenser housing. In this manner, the antenna is hidden from view and generally protected. A cover may be disposed over the recess to prevent access or inadvertent touching of the antenna by maintenance personnel. The cover should be perforated or otherwise contain passages for the free flow of air into the compartment.

As mentioned, the antenna may be in conductive communication with the web material along any portion of the conveying path of the web material through the internal volume of the dispenser. A collection plate, such as a foil plate or strip, may be disposed along the conveying path of the material at a location that ensures that the web material slides along the plate, such as where the web material changes direction. This collection plate is, in turn, in conductive communication with the antenna to dissipate static charge from the web material.

In an alternate embodiment, the antenna is in conductive communication with one or more internal components of the dispenser through an intermediate device. For example, the antenna and component(s) may we wired to a common collection point or node. In a particular embodiment, the component may be wired to a ground terminal within the dispenser's control circuitry, with the antenna wired to the same terminal.

It should be appreciated that the dispenser is not limited to any particular style, configuration, or intended type of web material. For example, the dispenser may be a towel dispenser, toilet tissue dispenser, or any other sheet material dispenser.

Various methods for dissipating static charge build-up in electronic sheet material dispensers are also within the scope and spirit of the invention, and include placing at least one component within the dispenser in electrical conductive communication with an antenna that is disposed relative to the dispenser housing to dissipate static charge to air surrounding the antenna, as discussed above.

Aspects of the invention will be described in greater detail below by reference to particular embodiments illustrated in the drawings.

### BRIEF DESCRIPTION OF THE DRAWINGS

FIG. 1 is a perspective view of an embodiment of an electronic dispenser according to the invention;

FIG. 2 is a perspective view of the dispenser of FIG. 1 with the front cover in its open position;

FIG. 3 is a perspective view of a removable module unit that may be utilized with the dispenser of FIG. 1;

FIG. 4A is a back perspective view of the dispenser of FIG. 1 particularly illustrating the antenna disposed in a recess in the back wall of the dispenser housing;

FIG. 4B is a perspective view of an alternate antenna recess configuration;

FIGS. 5A through 5D are partial perspective views of various components of the dispenser in conductive communication with the antenna of FIG. 5D; and

FIG. 6 is diagram view illustrating an alternative configuration of dispenser components in conductive communication with an antenna.

### DETAILED DESCRIPTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment, may be used with another embodiment, to yield still a further embodiment. It is intended that the present invention include modifications and variations to the embodiments described herein.

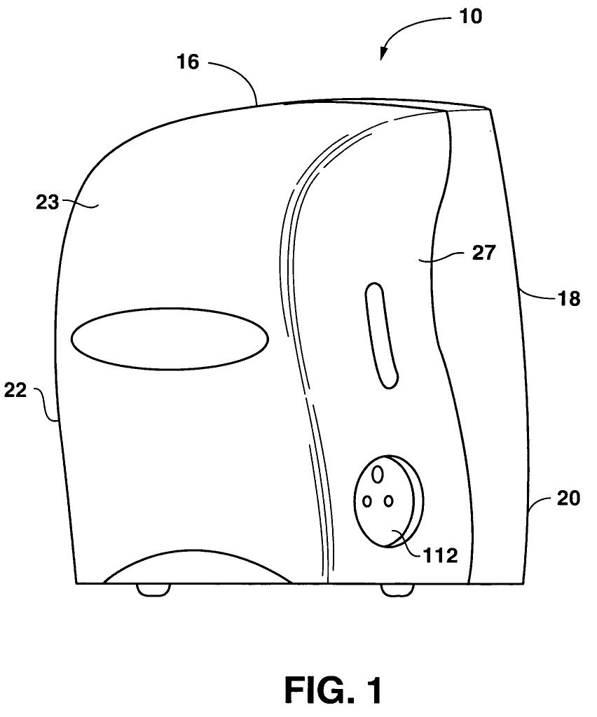

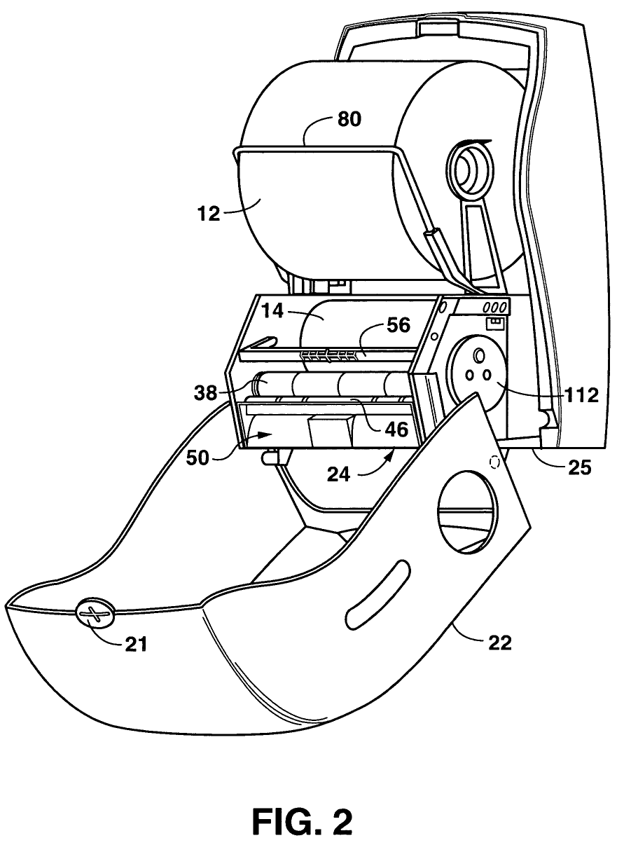

Referring particularly to FIGS. 1 through 3, an embodiment of a dispenser 10 according to the invention is illustrated. The dispenser 10 includes a housing 16 of any desired shape and configuration. The housing 16 includes a base 18 and a cover 22 pivotally mounted on the base 18 so as to be movable from the closed position illustrated in FIG. 1 to the open position illustrated in FIG. 2. The cover 22 includes a front wall 23 and side walls 27 that align with side walls 20 of the base 18 to define an interior volume for housing the operational components of the dispenser 10, as well as the rolls of web material to be dispensed, including a main roll 12 and a stub roll 14. Any conventional locking mechanism 21 (FIG. 2) may be provided to secure the cover 22 to the base 18. The housing 16 includes a bottom underside portion 25 with a throat (not visible) from which the material is dispensed.

The dispenser configuration 10 illustrated in FIGS. 1 and 2 is merely exemplary of any number of electronic dispenser configurations that may incorporate the static charge dissipation system and method in accordance with the invention. Also, a detailed explanation of the structural and control features of the dispenser 10 are not necessary for purposes of explanation of the static charge dissipating system and method of the invention, and will only be discussed briefly below.

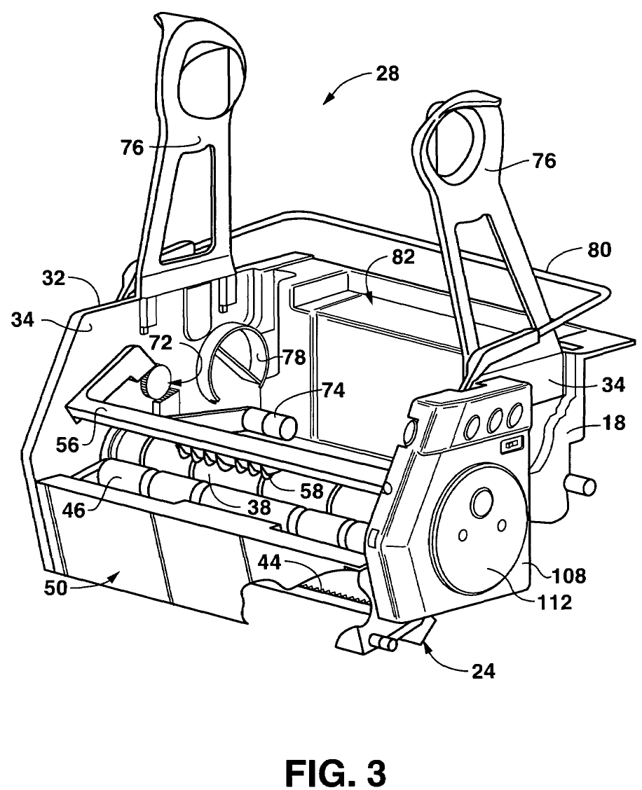

The operational components of the dispenser 10 may be mounted directly onto the base 18 within the interior volume of the housing 16. In an alternative embodiment, a dispensing module 28 is received in the housing 16, as seen in FIGS. 1 and 2, and the operational components are mounted within the module 28. The module 28 may be readily removable from the base 18 for servicing and/or replacing components without the necessity of having to remove the entire dispenser 10 from its support surface (i.e., wall). The housing 16 may be considered as a shell into which the module 28 of FIG. 3 is inserted and removed. The module 28 includes a frame or chassis 32 having left and right side plates 34. Within the module 28 between the side plates 34 are mounted the components of the dispensing mechanism 30, including a pressure roller assembly with a pressure roller 46, a transfer mechanism that includes a transfer arm 56, a throat assembly 50 that defines the throat 24 and includes a tear bar 44, a drive motor and gear assembly (not visible) that rotates drive roller 38, and control circuitry housed within a circuit housing 108.

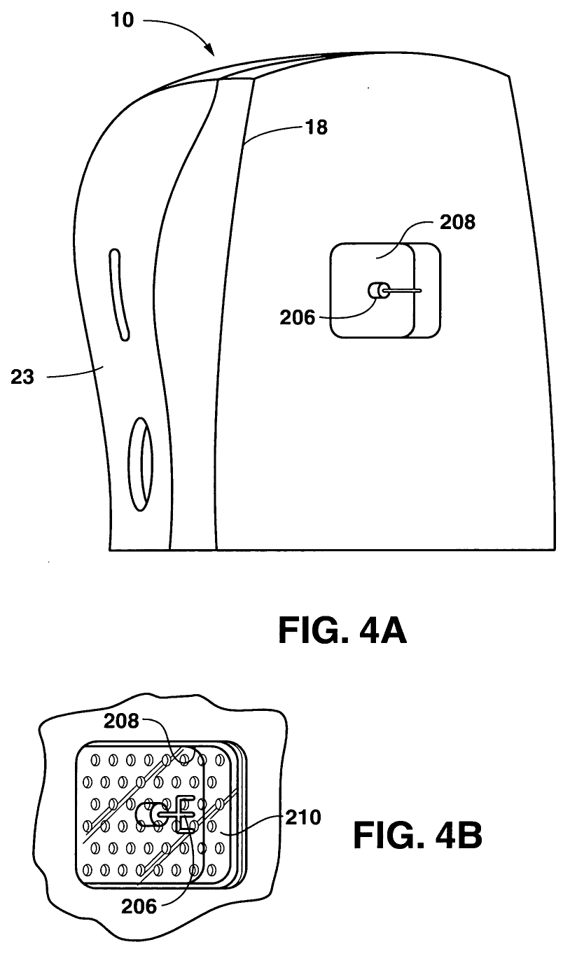

Left and right main roll holders 76 are attached to the module side plates 34, as seen in FIG. 4, and hold the main roll 12 of sheet material. Stub roll holders 78 are provided for rotatably supporting the stub roll 14 in the position within the module below and rearward of the main roll 12. It should be understood that a dispenser according to the invention need not be configured to dispense from a stub roll, and thus would not need a transfer mechanism. The dispenser may be configured for dispensing from a single roll of web material.

The pressure roller assembly with pressure roller 46 may be housed in the throat assembly 50 that is, in turn, mounted within the module 28. The throat assembly 50 includes a frame that may be fixed in position within the module, or pivotally mounted to the module 28 to facilitate loading of new rolls of web material. The cutter bar 44 within the throat assembly 50 is disposed along the dispensing path of the web material upstream of the dispensing opening 24 and downstream of the nip between a drive roller 38 and pressure roller 46. To separate a sheet of the web material that has been dispensed from the dispenser 10, a user grasps the sheet hanging from beneath the bottom portion 25 of the housing 16 and pulls the sheet forward against the cutter bar 44 such that the sheet tears and separates along the line defined by the cutter bar.

The pressure roller 46 is spring biased against the drive roller 38 such that the web material passing between the nip of the rollers is advanced along the dispensing path upon rotation of the drive roller 38. The throat assembly 50 defines a portion of the dispensing path and the forward portion of the dispensing throat 24.

The module 28 may include an automatic transfer mechanism to transfer dispensing of the web material from the stub roll 14 to a main roll 12 when the web material on the stub roll 14 is nearly fully depleted. From an operational standpoint, this transfer mechanism can operate substantially as described in U.S. Pat. No. 6,079,305 issued on Jun. 27, 2000, with the '305 patent incorporated herein in its entirety for all purposes. Referring to FIGS. 2 and 3, the transfer mechanism may include a transfer bar 56 with arms pivotally mounted to the module side plates 34 through gearing 72. The transfer bar 56 includes a “roller” section that may be defined by a central curved ribbed section 58. The section 58 includes a securing mechanism, such as a barb, such that the leading end of the web material from the main roll 12 passes over the roller section 58 and is held by the barb while material is feed from the stub roll 14. A stub roll sensing bar 74 is pivotally mounted to the module side plates 34 below stub roll holders 78, and is biased towards the axis of the stub roll holders 78 so as to track the decreasing diameter of the stub roll as it is depleted. The stub roll sensing bar 74 is configured with the gearing 72 that rotates upon pivotal movement of the sensing bar 74. As the stub roll is depleted, motion of the sensing bar 74 is transferred to the transfer bar 56 via the gearing 72. At a certain decreased diameter of the stub roll 14, the transfer bar 56 rotates to a position such that the leading end of the web material held by the bar 56 is brought by the roller section 58 into contact with the web material being dispensed from the stub roll causing the leading edge of the material from the main roll to be pulled from the arm 56 and conveyed with the material from the stub roll between the nip of the drive roller 38 and pressure roller 46. The “new” web material from the main roll 12 is dispensed simultaneously with the stub roll material until the stub roll is completely depleted. If no stub roll is present in the dispenser, the transfer bar 56 and roller section 58 contact against the web material dispensed from the main roll 12.

A spring biased “fuel gauge” bar 80 may be pivotally affixed to the side plates 34 and biased towards the center of the main roll 12 such that it tracks with the decreasing diameter of the main roll 12 as the web material is depleted. The bar may be biased from the front side of the roll, as depicted in the figures, or from any other side of the roll. When the main roll 12 reaches a diameter suitable for moving the roll to the stub roll position, a pawl (not visible) on the end of one of the arms of the bar 80 causes a switch in the control circuitry to close and activate an LED on the indicator plate 112. In this way, maintenance personnel are alerted that the main roll 12 is depleted and should be replaced.

A drive motor and gear assembly includes components mounted in the module 28, for example in a space under and behind the drive roller 38. The motor includes a drive shaft and a drive gear attached thereto that engages the shaft of the drive roller 38. Thus, upon energizing the motor, the drive roller 38 is caused to rotate, which results in conveyance of the web material disposed in the nip between the pressure roller 46 and drive roller 38 along the conveying path and out of the dispensing throat 24.

The dispensing mechanism may be powered by batteries contained in battery compartment 82 that is rearward of the stub roll holders 76 (see FIG. 3). Any suitable battery storage device may be used for this purpose. A conductor may be disposed below the battery compartment that mates with contacts on the underside of the battery compartment 82 for delivering power from the batteries to the circuitry in housing 108 and the drive motor. Alternatively, or in addition to battery power, the dispenser may also be powered by a building's AC distribution system. For this purpose, a plug-in modular transformer/adapter may be provided with the dispenser, which connects to a terminal or power jack port located, for example, in the bottom edge of the circuit housing 108 for delivering power to the control circuitry and associated components. The control circuitry may include a mechanical or electrical switch that isolates the battery circuit upon connecting the AC adapter in order to protect and preserve the batteries.

The dispenser control circuitry controls activation of the dispensing mechanism upon valid detection of a user for dispensing a metered length of the sheet material. Sensors and associated circuitry may be provided for this purpose. Various types of sensors are well known to those skilled in the art, including IR, RF, capacitive sensors, and so forth. Any one or combination of such sensing systems may be used. A detailed explanation of the sensing system is not necessary for purposes of the present disclosure. In the embodiment of the dispenser 10 illustrated in the figures, an IR sensing system may be used to detect the presence of a user's hands placed below the bottom portion 25 of the housing 16.

The control circuitry also controls the length of web material dispensed. Any number of optical or mechanical devices may be used in this regard. In the illustrated embodiment of the dispenser 10, an optical encoder may be used to count the revolutions of the drive roller 38, with this count is used by the control circuitry to meter the desired length of the sheet to be dispensed. Other systems may track the running time of the motor as the control variable, or detect perforations in the web material, and so forth.

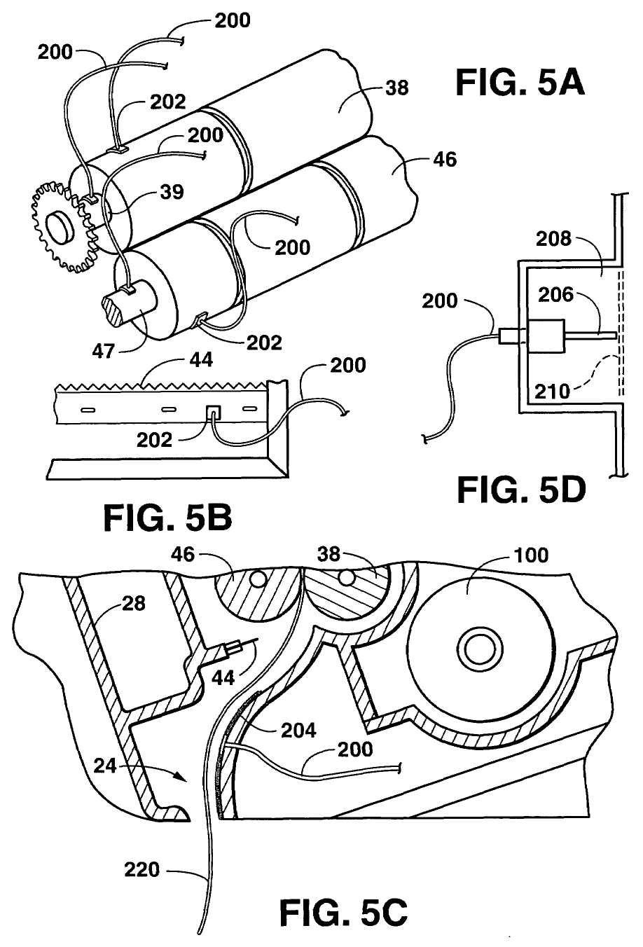

Aspects of the static charge dissipation system and method are described with reference to FIGS. 4 through 6. Referring to FIGS. 4A and 4B in particular, an antennae 206 is disposed in electrical conductive communication with at least one internal component of the dispenser 10 that is susceptible to generation and storage of static charge upon operation of the dispenser, as described in greater detail below. The antennae 206 is located relative to the dispenser so as to be exposed to the exterior of the dispenser. In a desirable embodiment, the antennae 206 is disposed within a recess 208 defined in the back wall of the base member 18 of the dispenser housing. In this embodiment, the base member 18 is formed of a non-conductive material, such as a plastic molded component. The recess 208 in the back wall of the base 18 hides and isolates the antennae 206 from users, and is only accessible upon removing the base member 18 from the supporting wall structure. Referring to FIGS. 4B and 5D, it may be desired to include a cover member 210 over the recess 208 to further isolate and protect the antennae 206. The cover 210 is perforated or otherwise includes air passages therethrough so that the interior volume of the recess 208 is exposed to free airflow.

It should be appreciated that the antennae 206 need not necessarily be disposed within a recess, and may be disposed at any location relative to the dispenser 10 so as to be externally exposed. For example, the antennae 206 could be disposed at the top of the dispenser 10, or below the dispenser 10 along the underside 25.

The configuration and type of antennae 206 may vary. In the embodiment illustrated in FIG. 4A, the antennae 206 comprises a single point array, and may be defined by, for example, an exposed wire or foil strip formed into a point. In the embodiment of FIG. 4B, the antennae 206 is defined by a multiple point array configuration, such as a branched configuration of multiple antennae arms. A multiple point antennae may be formed in various ways. For example, a strip of sheet metal may be bent into any desired antennae shape and have a plurality of individual “teeth” defined along the edge thereof, with each tooth constituting an antennae point. In another embodiment, a plurality of individual antennae points, such as copper barbs, may be welded or otherwise attached to a conductive metal base, such as a strip of sheet metal.

Although not intended to be limited to any particular operational principle, it is believed that the antenna 206 uses the relatively high static charge voltage of the dispenser component(s) to ionize air molecules and induce a corona discharge in the air surrounding the individual antenna points. Since the ions are subjected to the electric field concentrated at the antenna points, ions of a polarity opposite to the static charge polarity will travel along the electric field lines to the antenna, thereby neutralizing the field. The oppositely charged ions are neutralized as they move beyond the ionization region. This process continues until the field has been reduced to the point where ionization of the air ceases. This corona discharge principle is thus a function of the antenna's ability to induce ionization using the collected static charge from the components in conductive communication with the antenna. The electrical energy generated during this process is small and insufficient to create a spark.

As mentioned, any manner or combination of components within the dispenser 10 may be in electrical conductive communication with the antennae 206 for dissipating static charge. Referring to FIGS. 5A through 5C, various exemplary configurations are illustrated. In FIG. 5A, the drive roller 38 and pressure roller 46 are illustrated, along with their respective shafts. The surface of either of the rollers 38, 46 may be in conductive contact with a low impedance connection 200 (e.g., a wire) by any manner of suitable sliding contact 202. The low impedance connection 200 is illustrated in FIG. 5D as connected to the antennae 206 within the recess 208. Still referring to FIG. 5A, the shafts of either or both of the rollers may also be in communication with the antennae 206 through a respective low impedance connection 200. Because the components illustrated in FIG. 5A rotate, a suitable electrical wiper or slide contact would be used as the contacts 202. The conductive paths established by the low impedance conductors 200 may be defined at any convenient location within the interior volume of the dispenser 10.

FIG. 5B illustrates an embodiment wherein the tear bar 44 is in conductive communication with a low impedance connector 200 via connection 202. The tear bar 44 may be static or movably mounted and, thus, the connection 202 is appropriately configured to mate with the tear bar. For a static bar 44, the connection may be any suitable stationary electrical connection, such as a clip, pin, solder point, and so forth.

As discussed, the antennae 206 may be in conductive communication with the web material along any portion of the conveying path of the web material through the dispenser 10. Referring to FIG. 5C, a collection plate 204, such as a foil strip, web, or coating, may be disposed along the conveying path of the web material 220 at a location that ensures that the web material slides along the collection plate 204. This collection 204 is, in turn, in conductive communication through low impedance connection 200 with the antennae 206. In the embodiment of FIG. 5C, the collection plate 204 is depicted as disposed in the throat 24 of the dispenser just prior to the location where the web material 220 exits the dispenser. It should be appreciated that the static charge collection point may be located at any location of the conveying path of the web material, and that the illustration of FIG. 5C is an example of any suitable configuration.

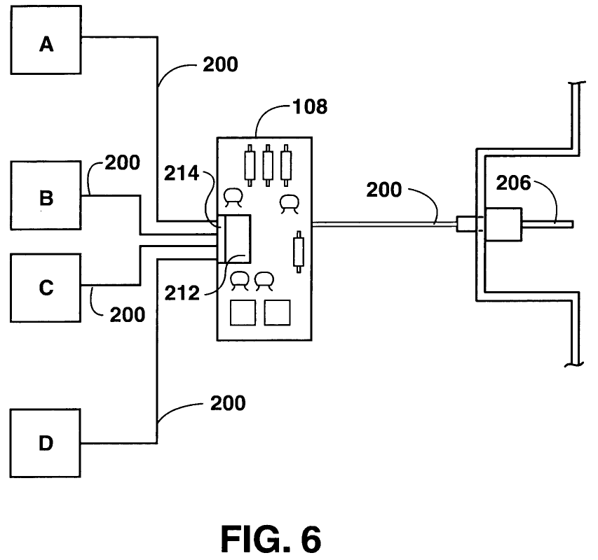

The antennae 206 may be in conductive communication with one or more of the internal components of the dispenser through an intermediate collection point or device. For example, referring to FIG. 6, components A through D represent various components of the dispenser 10 that may generate or store static discharge, as discussed above. These components are in electrical conductive communication via connection lines 200 with an intermediate device. In this particular embodiment, the intermediate device is a circuit component within the circuit housing 108. For example, the circuit component may be a circuit board 212 having a common ground bus or terminal 214 to which the connection lines 200 are attached. The bus or terminal 214 is, in turn, in communication with the antennae 206 through low impedance conductor 200. In an alternative embodiment, the intermediate member may be any device within the dispenser that functions as a common terminal or node for the various low impedance connection lines 200.

It should be appreciated by those skilled in the art that various modifications and variations may be made to features of the dispenser described herein, particularly to the mechanical and control circuitry aspects of the dispenser, without departing from the scope and spirit of the invention. It is intended that the invention include all such variations.

What is claimed is:

1. An electronic dispenser for dispensing a measured sheet from a roll of web material, comprising:
a housing having an internal volume so as to retain at least one roll of web material therein;
an electronically powered dispensing mechanism contained within said housing for dispensing a measured sheet from the roll of web material upon actuation of said dispensing mechanism; and
an antenna in conductive communication with at least one component of said dispenser that stores static charge generated by operation of said dispenser, said antenna being electrically isolated and disposed so as to dissipate the static charge through a non-conductive material external to said housing.

2. The dispenser as in claim 1, wherein said antenna is housed within a compartment that is open to external air, the static charge being dissipated through the air.

3. The dispenser as in claim 2, wherein said compartment is defined in a back surface of said housing.

4. The dispenser as in claim 3, wherein said compartment comprises a cover with air passages therethrough.

5. The dispenser as in claim 1, wherein said antenna comprises a single point array.

6. The dispenser as in claim 1, wherein said antenna comprises a multiple point array.

7. The dispenser as in claim 1, wherein said antenna is in conductive communication with the web material along a portion of the conveying path of the web material through said internal volume.

8. The dispenser as in claim 7, further comprising a collection plate along which the web material runs, said antenna is conductive communication with said collection plate.

9. The dispenser as in claim 1, wherein said antenna is in conductive communication with a component of said dispensing mechanism.

10. The dispenser as in claim 9, wherein said dispensing mechanism comprises a tear bar.

11. The dispenser as in claim 1, wherein said antenna is connected to said component through control circuitry in said dispenser.

12. The dispenser as in claim 11, wherein said control circuitry comprises a ground terminal or bus, said component and said antenna in conductive communication with said ground terminal or bus.

13. The dispenser as in claim 1, wherein said dispenser is configured as an automatic towel dispenser.

14. The dispenser as in claim 1, wherein said dispenser is configured as a toilet tissue dispenser.

15. A method for dissipating static charge build-up in an electronic sheet material dispenser configured to dispense a measured sheet from a roll of web material, comprising placing at least one component within the dispenser in electrical conductive communication with an antenna that is disposed relative to the dispenser housing to dissipate static charge to air surrounding the antenna.

16. The method as in claim 15, wherein the component within the dispenser is the web material as it is conveyed through the dispenser during a dispense sequence.

17. The method as in claim 16, further comprising directing the web material over a collection plate as it is conveyed through the dispenser, the collection plate in conductive communication with the antenna.

18. The method as in claim 15, comprising collecting static charge from a mechanical component of a dispensing mechanism within the dispenser and dissipating the static charge through the antenna.

19. The method as in claim 15, comprising exposing the antenna to air through a back surface of a housing for the dispenser.

20. The method as in claim 19, comprising disposing the antenna in a recess formed in the back surface of the housing.
